(19) United States
(12) Patent Application Publication
(10) Pub. No.: US 2021/0100369 A1
(43) Pub. Date: Apr. 8, 2021

(54) Walking Aid Apparatus for Toddlers

(71) Applicants: Eric Vincent Wright, JR., Philadelphia, PA (US); Sherona M P Coy, Monroe, NY (US)

(72) Inventors: Eric Vincent Wright, JR., Philadelphia, PA (US); Sherona M P Coy, Monroe, NY (US)

(21) Appl. No.: 16/591,248

(22) Filed: Oct. 2, 2019

(51) Int. Cl. A47D 13/04; A47D 15/00; A47D 1/00

(52) U.S. Cl. CPC A47D 13/043; A47D 1/004; A47D 1/0085; A47D 15/00

(57) ABSTRACT

An apparatus includes a support frame structure for supporting a walking aid. A seating device supports a toddler in a sitting or standing position. A tether implement secures the seating device to the support frame structure, wherein the frame members stabilize the apparatus on a supporting surface. A plurality of wheels disposed at a base of each of the plurality of frame members provides mobility on the supporting surface. L-shaped extensions are configured to extend each of the plurality of wheels further out than the support frame structure. A braking mechanism disposed on an underside of each L-shaped extension is configured to generally stop a movement of the apparatus or a rotation of the wheel when the wheel is no longer supported by the supporting surface. A handle implement disposed on the support frame structure is configured to be operable for steering the apparatus.

### CROSS-REFERENCE TO RELATED APPLICATIONS

Not applicable.

### RELATED CO-PENDING U.S. PATENT APPLICATIONS

Not applicable.

### INCORPORATION BY REFERENCE OF SEQUENCE LISTING PROVIDED AS ATEXT FILE

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### BACKGROUND OF THE RELEVANT PRIOR ART

One or more embodiments of the invention generally relate to a walking aid apparatus. More particularly, certain embodiments of the invention relate to a walking aid apparatus for toddlers.

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon. Walking aids for toddlers are typically known as baby walkers. A baby walker is an apparatus or a system that helps a toddler in getting accustomed to the walking movement, while preventing the toddler from falling down in the process. Some conventional baby walkers include a frame having a seating means attached thereto. The frame has a plurality of wheels, which allow the toddler to move the baby walker around while being seated on the seating means and moving its legs.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that some conventional baby walkers constantly hold the baby in a seated position on the seating means. As such, the toddler is moving its legs while being seated on the seating means. In the seated position, the toddler can take the support of the frame to move around via the wheels connected to the frame while being protected from falling down. It is believed that such an arrangement where the toddler is moving its legs while being seated may not be the best movement pattern that the toddler should get used to, as it does not allow the toddler to develop a proper gait.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A and FIG. 1B illustrate isometric views of a walking aid apparatus for toddlers, in accordance with an embodiment of the present invention,

FIG. 2A and FIG. 2B illustrate isometric views of the extension depicting the operation of a braking mechanism, in accordance with an embodiment of the present invention,

FIG. 3 illustrates an isometric view of the extension, in accordance with an embodiment of the present invention, and

FIG. 4 illustrates an isometric view depicting an operation of the walking aid apparatus, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settled law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” include the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising” And “contain” and variations of them—Such terms are open-ended and mean “including but not limited to”. When employed in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. .sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

All terms of exemplary language (e.g., including, without limitation, “such as”, “like”, “for example”, “for instance”, “similar to”, etc.) are not exclusive of any other, potentially, unrelated, types of examples; thus, implicitly mean “by way of example, and not limitation . . . ”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Moreover, any claim limitation phrased in functional limitation terms covered by 35 USC § 112(6) (post AIA 112(f)) which has a preamble invoking the closed terms “consisting of,” or “consisting essentially of,” should be understood to mean that the corresponding structure(s) disclosed herein define the exact metes and bounds of what the so claimed invention embodiment(s) consists of, or consisting essentially of, to the exclusion of any other elements which do not materially affect the intended purpose of the so claimed embodiment(s).

Devices or system modules that are in at least general communication with each other need not be in continuous communication with each other, unless expressly specified otherwise. In addition, devices or system modules that are in at least general communication with each other may communicate directly or indirectly through one or more intermediaries. Moreover, it is understood that any system components described or named in any embodiment or claimed herein may be grouped or sub-grouped (and accordingly implicitly renamed) in any combination or sub-combination as those skilled in the art can imagine as suitable for the particular application, and still be within the scope and spirit of the claimed embodiments of the present invention. For an example of what this means, if the invention was a controller of a motor and a valve and the embodiments and claims articulated those components as being separately grouped and connected, applying the foregoing would mean that such an invention and claims would also implicitly cover the valve being grouped inside the motor and the controller being a remote controller with no direct physical connection to the motor or internalized valve, as such the claimed invention is contemplated to cover all ways of grouping and/or adding of intermediate components or systems that still substantially achieve the intended result of the invention.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Walking aid devices for toddlers are typically known as baby walkers. Some conventional baby walkers have a frame and seat connected to the frame. The frame also has a plurality of wheels connected thereto. How these conventional baby walkers work is that a toddler is placed on the seat, and the height of the seat is such that the legs of the toddler are in contact with the floor. The frame is typically of the type that circumscribes the toddler while the toddler is seated in the seat. As such, no matter which direction the toddler moves, the toddler may use the frame for support and its legs for pushing the baby walker. In this manner, the toddler can move around in the conventional baby walkers.

A disadvantageous aspect of these conventional baby walkers is that while the toddler is moving around in the baby walker, the toddler is seated the entire time. Being seated and moving the legs to move the baby walker around impedes the proper development of the leg muscles because the toddler is not in a standing position while moving around in the baby walker. For proper gait development, it is desirable that the toddler be supported in a standing position, while the toddler is learning to walk.

The present invention will now be described in detail with reference to embodiments thereof as illustrated in the accompanying drawings.

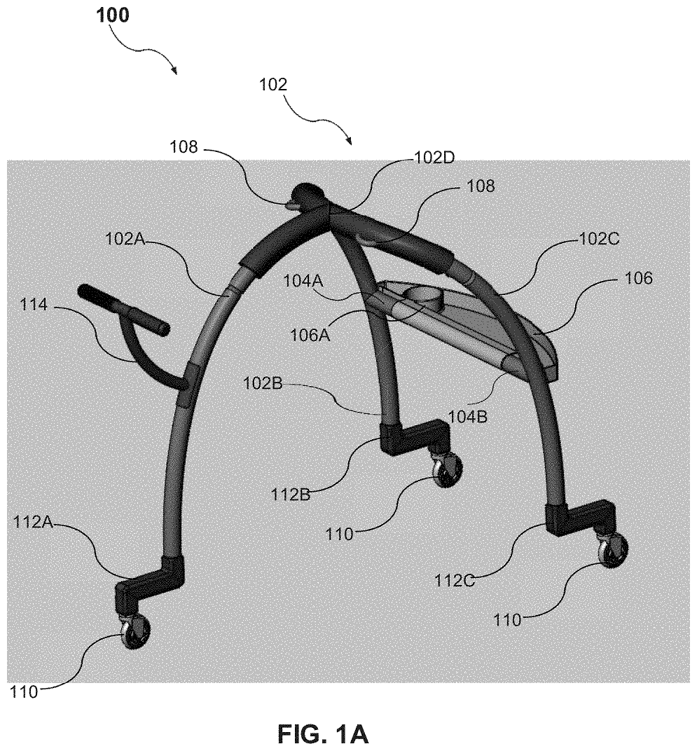

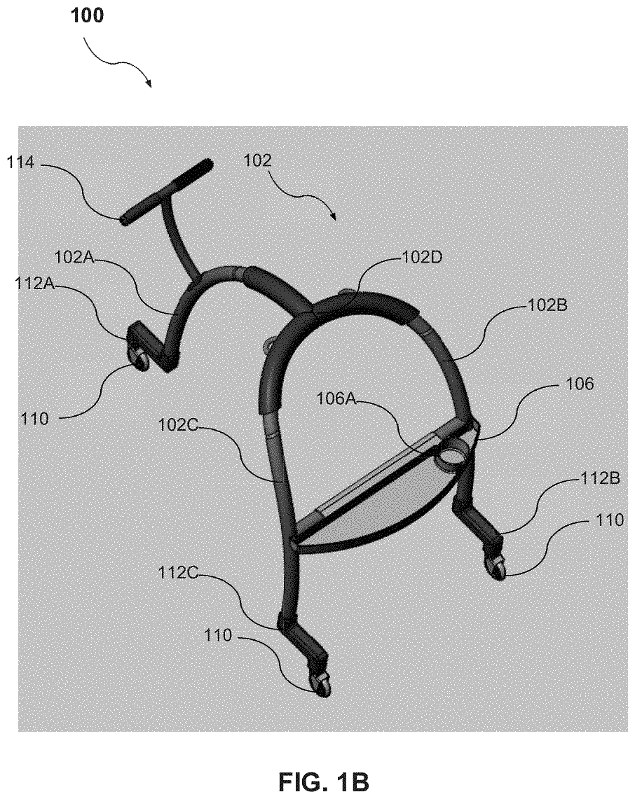

FIG. 1A and FIG. 1B illustrate isometric views of a walking aid apparatus for toddlers 100 (hereinafter referred to as apparatus 100), in accordance with an embodiment of the present invention. Referring to FIG. 1A and FIG. 1B, the apparatus 100 comprises a frame structure 102. The frame structure 102 includes an over-head support frame for supporting a toddler in a sitting or standing position, seating means from at least shoulder height or higher. The frame structure 102 comprises three frame members or legs 102A, 102B, 102C converging at a joining portion 102D. More specifically, one operative end of each of the frame members 102A, 102B, 102C are connected at the joining portion 102D. In one embodiment of the present invention, the operative ends of the frame members 102A, 102B, 102C are welded to form the joining portion 102D. In an alternative embodiment, the operative ends of the frame members 102A, 102B, 102C may be modular and may be connected using brackets and fasteners such as nut and bolt assemblies. An advantageous aspect of modular frame members is that it facilitates easy storage and conveyance of the apparatus 100. In yet another alternative embodiment, the joining portion 102D may be defined by a hollow attachment having a rigid construction and three arms for securely receiving operative ends of each of the frame members 102A, 102B, 102C. The secure reception or fitment of the frame members 102A, 102B, 102C inside the attachment defining the joining portion 102D may be facilitated by nut and bolt assemblies. In yet another alternative embodiment, the secure reception or fitment of the frame members 102A, 102B, 102C inside the attachment defining joining portion 102D may be facilitated by snap fit formations configured on the frame members 102A, 102B, 102C as well as on the attachment defining the joining portion 102D. In one embodiment, the frame members 102A, 102B, 102C may be made of at least one of a plastic material, an alloy material, a metallic material or a combination thereof.

In accordance with an embodiment of the present invention, frame members 102A, 102B, 102C may have a telescopic configuration that facilitates the variation of operating height of the frame members 102A, 102B, 102C. An advantageous aspect of the height adjustable frame members 102A, 102B, 102C is that it makes the apparatus 100 usable for toddlers of different height. More specifically, even as the toddler keeps on growing tall, the apparatus 100 is not deemed unusable. One can simply change the operating height of the frame members 102A, 102B, 102C to accommodate the toddler within the frame 102.

It is to be noted frame member 102A is the rear frame member and frame members 102B, 102C are front frame members. The front frame members 102B, 102C have support members 104A, 104B configured at substantially central locations thereon and extending inwardly therefrom. Frame members 102B and 102C may have two support member bar weldment 104A, 104B. The support members 104A, 104B facilitate a fitment of a tray 106 thereon. The tray 106 includes a hollow cylindrical protrusion 106A configured thereon for allowing a placement of a container therewithin. The tray 106 itself can be used to hold items such as small toys and the like. In one embodiment, the tray 106 may be made of at least one of a plastic material, an alloy material, a metallic material or a combination thereof.

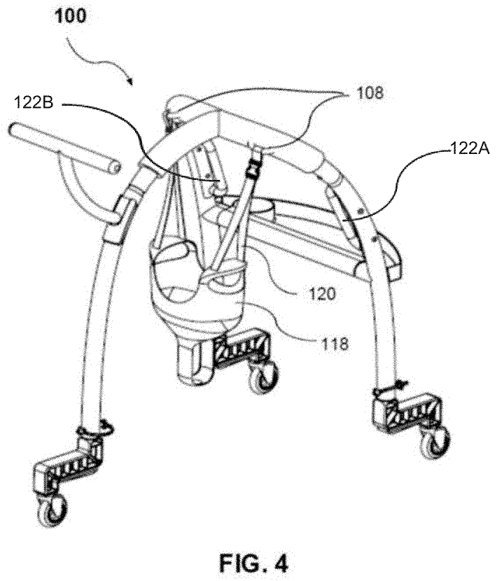

The apparatus 100 further comprises at least one tethering loop 108 configured on frame members 102B, 102C adjacent the joining portion 102D. In an alternate embodiment, the at least one tethering loop 108 may be configured on different arms of the hollow attachment defining the joining portion 102D. An adjustable tether implement 120 (FIG. 4) attached to the tethering loops 108 facilitate the tethering of a seating device or support means 118 (see FIG. 4) for a toddler thereon. The toddler is supported within the seating device or support means 118 tethered to the tethering loops 108, as shown in FIG. 4. The tether implement has an adjustable strap device that connects opposite ends of the seating device to the tethering loops where the adjustable strap device is configured to cause an adjustment of a height of the seating device from the supporting surface. In additional embodiments, the adjustable strap device may include a spring coil that is configured to support a child in the seating device to bounce up and down. An advantageous aspect of such a configuration of the tether implement 120, tethering loops 108 and seating device or support means is that the toddler can also hold on to the tray 106 for support, which tray 106 is mounted on the support members 104A, 104B. In one embodiment, the seating device 118 may have adjustable straps 120 (FIG. 4) to facilitate variation of height at which the seating device 118 is supported via the tethering loops 108.

The apparatus 100 further comprises a plurality of wheels 110. The plurality of wheels 110 are mounted on extensions 112A, 112B, 112C. The extensions 112A, 112B, 112C extend from the frame members 102A, 102B, 102C. In an embodiment, the extensions 112A, 112B, 112C have an L-shaped configuration. The L-shape extensions are configured to extend the wheels 110 further out than the frame, which may act as a safety feature so that if the wheels are no longer supported by the floor, the frame falls on the L-shape extension that houses a brake pad halting further rolling movement. The brake pad may include a rubber stopper that causes friction on a surface. Alternatively, the brake pad is a spring loaded braking mechanism. In another embodiment, the extensions 112A, 112B, 112C are configured to extend along the length of the apparatus 100. An advantageous aspect of such a configuration of the extensions 112A, 112B, 112C is that it prevents the apparatus 100 from being obstructed in a doorway. The extensions add length to the apparatus so that it won't fit through a standard doorway sideways. In this regard, it is wider than a standard doorway and won't have a chance to accidently roll down a stairwell sideways. This is a preventative measure as one requirement by consumer safety regulations. In an embodiment, the wheels 110 have a modular configuration and can be removed to make the apparatus 100 immobile or stationary. The L-Shaped extensions with the wheels may be removed together. In an embodiment, the extensions 112A, 112B, 112C are integral to the frame members 102A, 102B, 102C. In another embodiment, the extensions 112A, 112B, 112C are modular components that can be press fitted or snap fitted onto the frame members 102A, 102B, 102C.

In an alternative embodiment, where wheels 110 are removed from the extensions 112A, 112B, 112C, both L-shaped extension with wheels can be removed, and the apparatus 100 is stationary, the apparatus 100 may include support means tethered to the tethering loops 108. The support means may be resilient or spring loaded straps similar to bungee jumping straps that fit onto the thighs of the toddler. This allows the toddler to jump safely while taking the support of the tray 106 and while being supported via the support means. Such a configuration facilitates the use of the apparatus 100 as a jumper.

The apparatus 100 further comprises a handle implement 114. The handle implement 114 is configured on the rear frame member 102A for steering or maneuvering the apparatus. An advantageous aspect of the handle implement 114 is that it allows a parent to maneuver the apparatus 100 in order to prevent the toddler from hitting objects that lie in the path of the apparatus 100, e.g., a show pieces, a table, and the like. In an embodiment, the handle implement 114 is height adjustable and removeable yes this is ok and has a modular configuration that can be press fitted or interlocked to the frame member 102C. In alternative embodiments, the handle implement 114 may be removeably configured on frame member 102A. In some embodiments, the handle implement 114 may include a removable parental steering accessory that interlocks to the frame member. In an embodiment, the handle 114 may be made of at least one of a plastic material, an alloy material, a metallic material or a combination thereof.

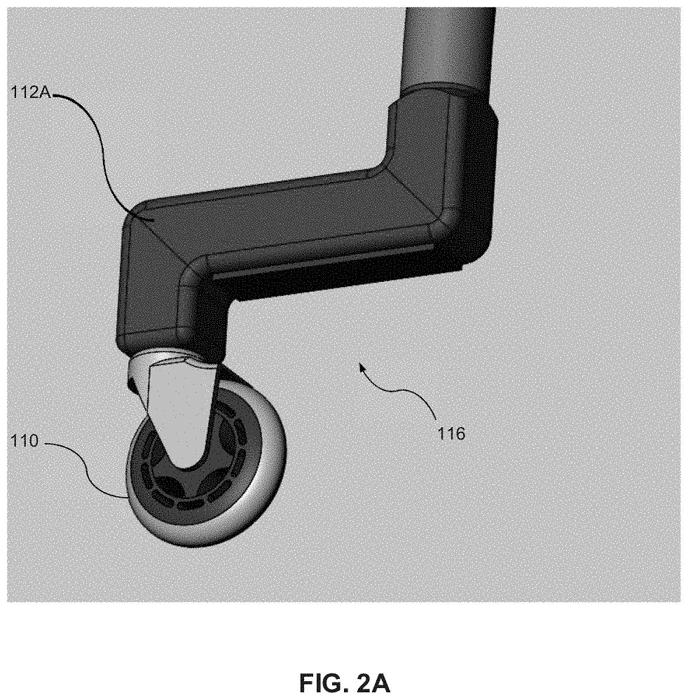

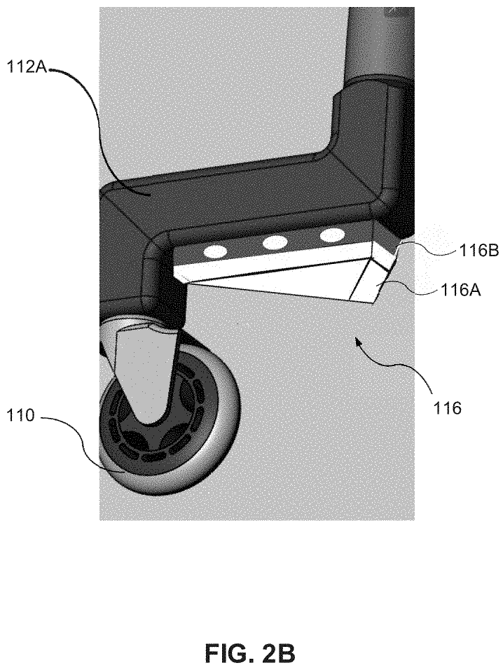

The apparatus 100 further comprises a braking mechanism 116. FIG. 2A and FIG. 2B illustrate isometric views of the extension depicting the operation of braking mechanism 116, in accordance with an embodiment of the present invention. As seen in FIGS. 2A and 2B, the braking mechanism 116 is configured at an underside of at least one of the extensions 112A, 112B, 112C. The extensions 112A, 112B, 112C have an L-shaped configuration. An advantageous aspect of such a configuration of the extensions 112A, 112B, 112C is that whenever the toddler pushes the apparatus 100 to a location having a ground level lower than that of the location on which the toddler is supported, e.g., a step, the L-shaped profile of the extensions 112A, 112B, 112C causes the wheel 110 to be pushed ahead and the underside of the extensions 112A, 112B, 112C interacts with the flat surface of the step. This interaction stops the forward movement of the apparatus 100. At that instant, the braking mechanism 116 is pressed, wherein braking mechanism 116 is disposed at the underside of the extensions 112A, 112B, 112C. The pressing of the braking mechanism 116 against the step acts as the actuation force to actuate the braking mechanism 116 itself. In one embodiment, the braking mechanism 116 is a spring loaded braking mechanism that activates when pressed against a flat surface such as a step. As the braking mechanism 116 is actuated, it extends downwardly out of the extensions 112A, 112B, 112C to further lift the extensions 112A, 112B, 112C to ensure that the wheels 110 are no longer in contact with any surface, thereby stopping any possible forward movement.

In another embodiment, the braking mechanism 116 comprises a first braking extension 116A and a second braking extension 116B. The first braking extension 116A and the second braking extension 116B are spring loaded braking extensions. As the braking mechanism 116 is pressed against a surface, the first braking extension 116A is activated and extends downwardly out of the extension 112A, 112B, 112C. The activation of the first braking portion 116A triggers the activation of the second braking extension 116B, which is also spring loaded, further lifting the extension 112A, 112B, 112C and braking any contact of the wheel 110 with any surface. In an alternative embodiment, the surface of the braking mechanism 116 being pressed against may have an abrasive surface finish to increase the friction with the surface against which the braking mechanism 116 is being pressed.

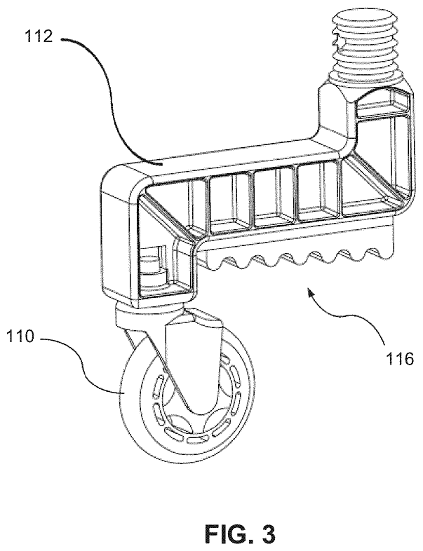

FIG. 3 illustrates an isometric view of the extension 112, in accordance with an embodiment of the present invention. Extension 112 includes a braking mechanism 116 which may include an abrasive surface finish to increase the friction with the surface against which the braking mechanism 116 is being pressed when wheel 110 is no longer in contact with a surface.

FIG. 4 illustrates an isometric view depicting an operation of the walking aid apparatus 100, in accordance with an embodiment of the present invention. The walking aid apparatus 100 may include a tether loop 108, a seating device 118, and an adjustable tether implement or strap device 120 connecting opposite ends of seating device 118 to tether loop 108. As seen in FIG. 4, the apparatus 100 further comprises handles 122A, 122B configured on the frame members 102A, 102B. The handles 122A, 122B are provided to allow the toddler to hold on to the apparatus 100. The toddler can either hold on to the tray 106 or the handles 122A, 122B while being supported by the apparatus 100.

An advantageous aspect of apparatus 100, in accordance with embodiments of the present invention, is that the apparatus 100 allows the toddler to be supported in a standing position. In the standing position, the entire load of the body weight is taken up by the legs of the toddler, which facilitate the proper development of the leg muscles of the toddler. Another advantageous aspect of apparatus 100 is that as the child is learning to walk in the standing position, it is easier for the child to develop proper gait. This is in contrast with the conventional baby walkers in which the toddler learns to walk while being seated the entire time, thus developing an improper gait.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” or “steps for” claim limitation implies that the broadest initial search on 35 USC § 112(6) (post AIA 112(f)) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112(6) (post AIA 112(f)) when such corresponding structures are not explicitly disclosed in the foregoing patent specification. Therefore, for any invention element(s)/structure(s) corresponding to functional claim limitation(s), in the below claims interpreted under 35 USC § 112(6) (post AIA 112(f)), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112(6) (post AIA 112(f)) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112(6) (post AIA 112(f)), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a walking aid apparatus for toddlers according to the present invention will be apparent to those skilled in the art. Various aspects of the invention have been described above by way of illustration, and the specific embodiments disclosed are not intended to limit the invention to the particular forms disclosed. The particular implementation of the walking aid apparatus for toddlers may vary depending upon the particular context or application. By way of example, and not limitation, the walking aid apparatus for toddlers described in the foregoing were principally directed to allow toddlers to develop proper gait by facilitating proper development of leg muscles; however, similar techniques may instead be applied as walking aid to those recuperating from leg injuries or for providing walking aid to the elderly, children, and adolescent suffering physical ailments such as cerebral palsy or muscular dystrophy diseases, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

Only those claims which employ the words “means for” or “steps for” are to be interpreted under 35 USC 112, sixth paragraph (pre AIA) or 35 USC 112(f) post-AIA. Otherwise, no limitations from the specification are to be read into any claims, unless those limitations are expressly included in the claims.

What is claimed is:

1. An apparatus comprising:
a support frame structure, said support frame structure comprises at least a plurality of frame members, wherein said frame members are configured to support a walking aid;
a seating device, wherein said seating device is configured to be operable for supporting a toddler, child, infant or baby in a sitting or standing position;
a tether implement disposed on said support frame structure, wherein said tether implement is configured to secure said seating device to said support frame structure;
wherein said plurality of frame members are further configured to be operable for stabilizing said apparatus on a supporting surface;
a plurality of wheels, each wheel being disposed at a base of each of said plurality of frame members for rolling motion on the supporting surface;
a plurality of L-shaped extensions, each L-shaped extension is configured to extend each of said plurality of wheels further out than said support frame structure;
a braking mechanism disposed on an underside of each L-shaped extension, wherein said braking mechanism is configured to generally stop a movement of said apparatus or a rotation of said wheel, when said wheel is no longer supported by the supporting surface; and
a first handle implement disposed on said support frame structure, wherein said first handle implement is configured to be operable for an adult to steer said apparatus.

2. The apparatus of claim 1, further comprising a joining portion, in which said frame members are connected at said joining portion, wherein said frame members are configured to form an overhead support frame structure.

3. The apparatus of claim 2, in which said braking mechanism is further configured to generally stop a movement of said apparatus or a rotation of said wheel when said braking mechanism interacts with a surface.

4. The apparatus of claim 1, further comprising a tray implement that is configured to hold items including small toys.

5. The apparatus of claim 4, further comprising tray support members configured to facilitate a fitment of said tray implement.

6. The apparatus of claim 5, in which said tray implement comprises a hollow cylindrical protrusion that is configured to be operable for allowing a placement of a container there within.

7. The apparatus of claim 1, in which said first handle implement comprises a removable parental steering accessory that interlocks to said support frame structure.

8. The apparatus of claim 1, in which said plurality of frame members or legs are collapsible or modular for easy breakdown, storage, or travel.

9. The apparatus of claim 1, in which said plurality of frame members are height adjustable.

10. The apparatus of claim 1, in which handle implement is a steering means connected to at least one of said frame members for direction control and support while said apparatus is in motion or standing.

11. The apparatus of claim 1, in which said tether implement comprises one or more tethering loops, wherein said one or more tethering loops are configured to facilitate the tethering of said seating device.

12. The apparatus of claim 11, in which said tether implement further comprises an adjustable strap device that is configured to connect opposite ends of said seating device to said tethering loops, wherein said adjustable strap device is further configured to cause an adjustment of a height of said seating device from the supporting surface.

13. The apparatus of claim 1, in which said seating device comprises a spring coil, wherein said spring coil is configured to support a child in said seating device to bounce up and down.

14. The apparatus of claim 1, in which said plurality of wheels are detachable and replaceable to make it stationary.

15. The apparatus of claim 1, in which each of said plurality of wheels have a braking mechanism to stop a rolling movement of each wheel.

16. The apparatus of claim 1, in which said apparatus comprises a hard material including metals, alloys or plastics or a combination thereof.

17. The apparatus of claim 1, further comprising a second handle implement which is configured to be operable for the toddler to grab onto for support and for at least partially guiding the direction of movement of said apparatus.

18. The apparatus of claim 1, further comprising a tray area made of plastic, alloy, metal or a combination thereof and is removable.

19. An apparatus comprising:
means for supporting said apparatus, wherein said apparatus comprises a walking aid apparatus;
means for supporting a toddler, child, infant or baby in a sitting or standing position;
means for securing said toddler supporting means to said apparatus supporting means;
means for providing a rolling motion to said apparatus supporting means;
means for extending said rolling motion providing means;
means for stopping a movement of said apparatus when said rolling motion providing means is no longer supported by a supporting surface;
means for steering said apparatus supporting means; and
means for joining said apparatus supporting means.

20. An apparatus comprising:
a support frame structure, said support frame structure comprises at least a plurality of frame members, wherein said frame members are configured to support a walking aid;
a seating device, wherein said seating device is configured to be operable for supporting a toddler, child, infant or baby in a sitting or standing position;
a tethering implement, wherein said tethering implement is configured to secure said seating device to said support frame structure;
wherein said plurality of frame members are further configured to be operable for stabilizing said apparatus on a supporting surface;
a plurality of wheels, each wheel is configured to provide mobility to said support frame structure on the supporting surface;
a plurality of L-shaped extensions, wherein each L-shaped extension is configured to extend each wheel further out than said support frame structure;
a braking mechanism disposed on each L-shaped extension, wherein said braking mechanism is configured to generally stop a movement of said apparatus or a rotation of said wheel, when said wheel is no longer supported by the supporting surface;
a handle implement, wherein said handle implement is configured to be operable for steering said apparatus;
a joining portion, in which said frame members are connected at said joining portion to form an overhead support frame structure; and
a tray implement, wherein said tray implement is configured to hold items, objects, or small toys.
